(19) United States
(12) Patent Application Publication
(10) Pub. No.: US 2025/0180753 A1
(43) Pub. Date: Jun. 5, 2025

(54) SYNCHRONIZING A SPREADING CODE WITH A CARRIER

(71) Applicant: Higher Ground LLC, Palo Alto, CA (US)

(72) Inventors: Darren Robert REIS, Palo Alto, CA (US); Bruce Leonard MCKINLEY, South Riding, VA (US)

(21) Appl. No.: 18/891,357

(22) Filed: Sep. 20, 2024

Related U.S. Application Data
(60) Provisional application No. 63/605,652, filed on Dec. 4, 2023.

(51) Int. Cl. G01S 19/07; G01S 19/04

(52) U.S. Cl. CPC G01S 19/07; G01S 19/04

(57) ABSTRACT

According to one or more of the embodiments herein, systems and techniques are provided for synchronizing a spreading code with a carrier, such as for Global Navigation Satellite Systems (GNSS) and associated codes which incorporate a navigation message modulated by a spreading code with a carrier, e.g., for facilitating precise measurement of time of flight (ToF) of received weak signals which are relayed via an intermediary device. Specifically, the techniques herein provide for synchronizing the phase of a spreading code with the phase of the relayed carrier signal. The techniques herein ensure that at a relaying device, the phase of a code modulated by a downlink carrier signal is aligned with the phase of the downlink carrier signal.

### RELATED APPLICATION

This application claims priority to U.S. Prov. Appl. Ser. No. 63/605,652, filed Dec. 4, 2023, entitled SYNCHRONIZING A SPREADING CODE WITH A CARRIER, by, Reis, et al., the contents of which are incorporated herein by reference.

### TECHNICAL FIELD

The present disclosure relates generally to position, navigation and timing systems and wireless communication systems, and, more particularly, to synchronizing a spreading code with a carrier.

### BACKGROUND

Global Navigation Satellite Systems (GNSS) utilize a plurality of satellites to facilitate location determination of devices such as handheld devices, flying objects, vehicles, etc. In most GNSS applications, each satellite in a constellation broadcasts a signal identifying itself and providing its precise time, and potentially its orbit location. A device can determine its location by receiving signals from multiple GNSS satellites and determining its distance from the respective satellites. Alternatively, a device may determine its location by analyzing the difference between the times of arrival of signals from a plurality of GNSS satellites.

GNSS satellites orbit at about 19,000 to 36,000 kilometers (11,800 to 22,400 miles) above the Earth's surface and as such the signal received at the navigating devices from these satellites is rather weak. In addition, multipath affects at the receiver cause estimation errors in the determination of the time of arrival (ToA) of the code. To enhance the ability of the navigating devices to properly estimate ToA of the code, the GNSS satellites synchronize the code with the carrier. Since the carrier and the code are generated in and transmitted from the GNSS satellite, synchronizing these two signals is straightforward and does not introduce a major technical issue.

GNSS signals are well defined and therefore are easy to jam by transmitting a powerful signal in the GNSS signal band. More sophisticated attacks against GNSS may spoof the well-known GNSS signals causing navigation devices to report erroneous location. To address this, novel methods for mitigating the jamming and spoofing location determination were introduced in the following U.S. patents and Publications:
U.S. Pat. No. 11,770,714, entitled “SATELLITE ECHOING FOR GEOLOCATION AND MITIGATION OF GNSS DENIAL”;
U.S. Pat. No. 11,736,946, entitled “SATELLITE RELAYING FOR GEOLOCATION AND MITIGATION OF GNSS DENIAL”;
U.S. Pat. No. 11,349,559, entitled “ACCURATELY DETERMINING A ROUND TRIP TIME TO A SATELLITE”;
U.S. Pat. No. 11,638,153, entitled “INTERFEROMETRY-BASED SATELLITE LOCATION ACCURACY”;
U.S. Pat. No. 11,346,957, entitled “TRILATERATION-BASED SATELLITE LOCATION ACCURACY FOR IMPROVED SATELLITE-BASED GEOLOCATION”;
U.S. Patent Publication No. 2021-0311201, entitled “MULTI-SYSTEM-BASED DETECTION AND MITIGATION OF GNSS SPOOFING”; and
U.S. Patent Publication No. 2021-0311202, entitled “MULTI-SUBSET-BASED DETECTION AND MITIGATION OF GNSS SPOOFING”.

Rather than generating well-known standard GNSS signals in the GNSS satellites and transmitting them downwards to navigating devices, these novel methods above generate the location determination signals in a ground-based device. The fact that the signal is generated at a ground-based device rather than in the satellite gives the generating device the flexibility to alter the parameters of the signal, e.g., frequency, modulation, encoding scheme, encryption, etc., thus making it difficult to jam or to spoof the location determination signals.

Illustratively, Tracking and Data Relay Satellite (TDRS) can be used to relay, or transpond, the location determination signals. TDRS are GEO satellites placed at an altitude of approximately 35,800 kilometers (22,300 miles) directly above the equator. Because of their high altitude, signals relayed via TDRS arrive at the navigating devices at a very low power making it difficult for navigating devices such as handheld devices with a small antenna to reliably estimate the time of arrival of the signals.

### SUMMARY

According to one or more of the embodiments herein, systems and techniques are provided for synchronizing a spreading code with a carrier, such as for Global Navigation Satellite Systems (GNSS) and associated codes which incorporate a navigation message modulated by a spreading code with a carrier, e.g., for facilitating precise measurement of time of flight (ToF) of received weak signals which are relayed via an intermediary device. Specifically, the techniques herein provide for synchronizing the phase of a spreading code with the phase of the relayed carrier signal. The techniques herein ensure that at a relaying device, the phase of a code modulated by a carrier signal is aligned with the phase of the carrier signal.

In one embodiment, an illustrative method herein may comprise: determining, by a device, a downlink carrier frequency and a code signal for a transmission through a relaying device to a receiving device; adjusting, by the device, a phase of the code signal to result in a synchronized phase of the code signal with the downlink carrier phase at the relaying device; and initiating, by the device, the transmission from a transmitting device through the relaying device and to the receiving device.

In one embodiment, a processing device is caused to calculate a ranging measurement between the relaying device and the receiving device based on the synchronized phase of the code signal with the downlink carrier phase from the relaying device being received at the receiving device. In one embodiment, the processing device uses the ranging measurement between the relaying device and the receiving device as part of determining a location of the receiving device.

Other embodiments of the present disclosure may be discussed in the detailed description below, and the summary above is not meant to be limiting to the scope of the invention herein.

### BRIEF DESCRIPTION OF THE DRA WINGS

The embodiments herein may be better understood by referring to the following description in conjunction with the accompanying drawings in which like reference numerals indicate identically or functionally similar elements, of which:

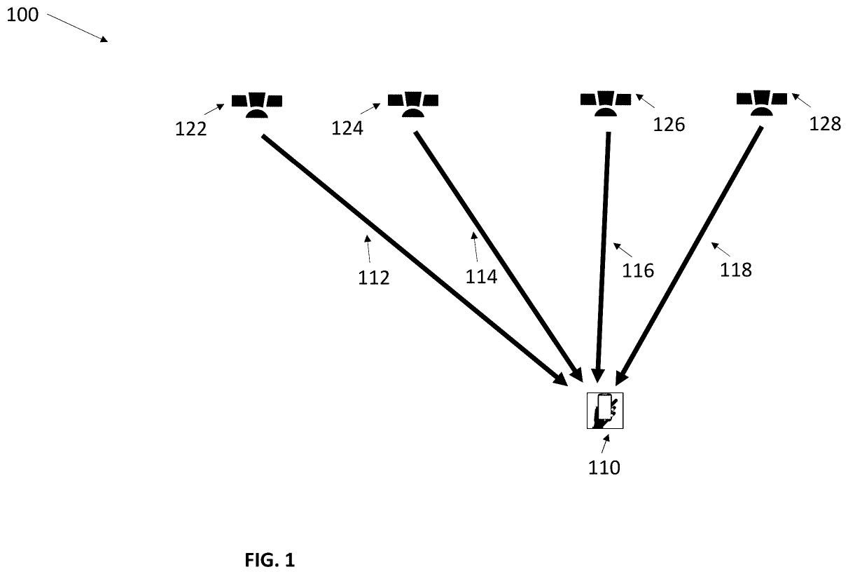

FIG. 1 illustrates an example of a Global Navigation Satellite Systems (GNSS) system;

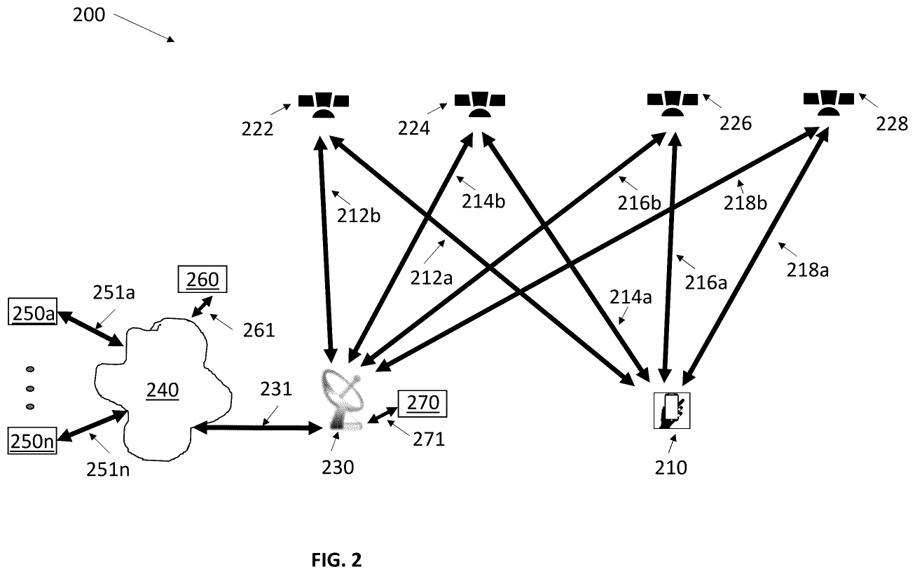

FIG. 2 illustrates an example system that utilizes a communication system for determining location of a navigating device;

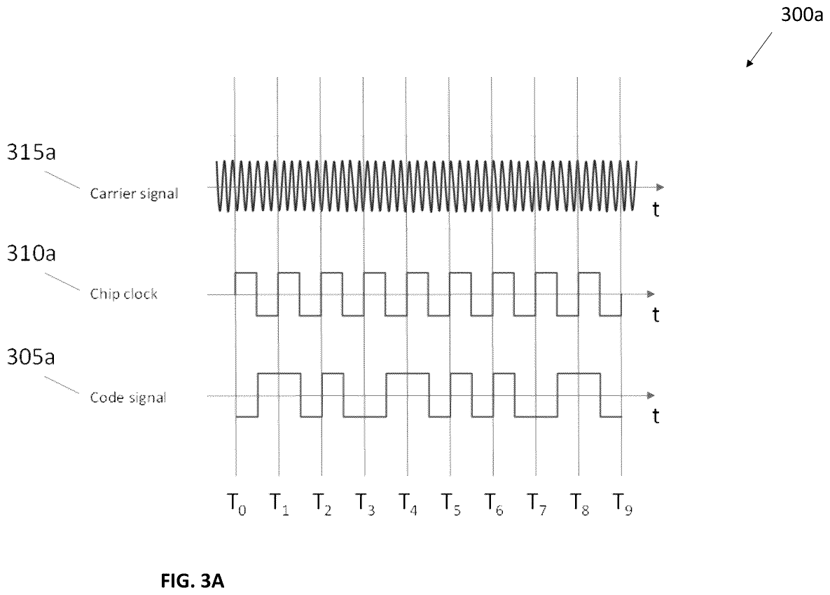

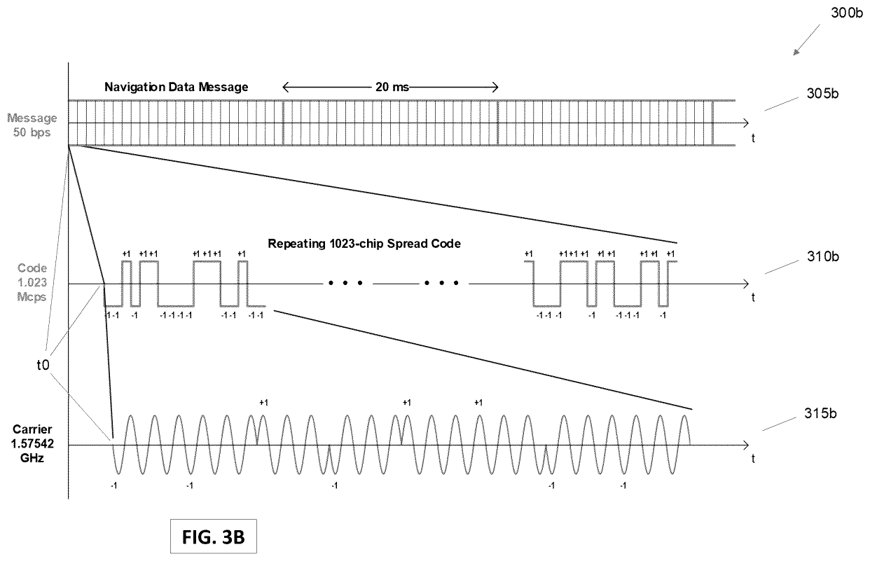

FIGS. 3A-3B illustrate examples of simplified signals synchronization between a code and a carrier;

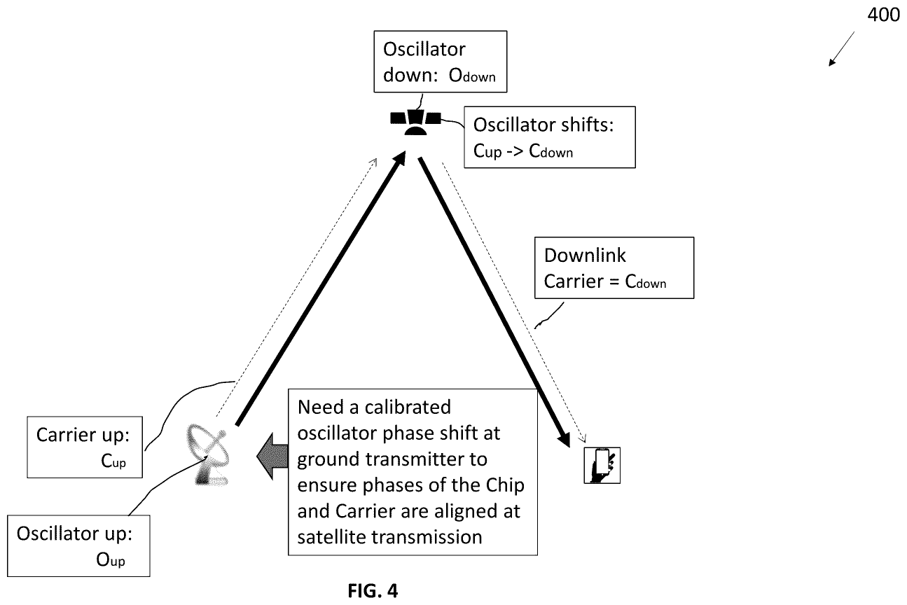

FIG. 4 illustrates an example visualization of synchronization between a code and a carrier;

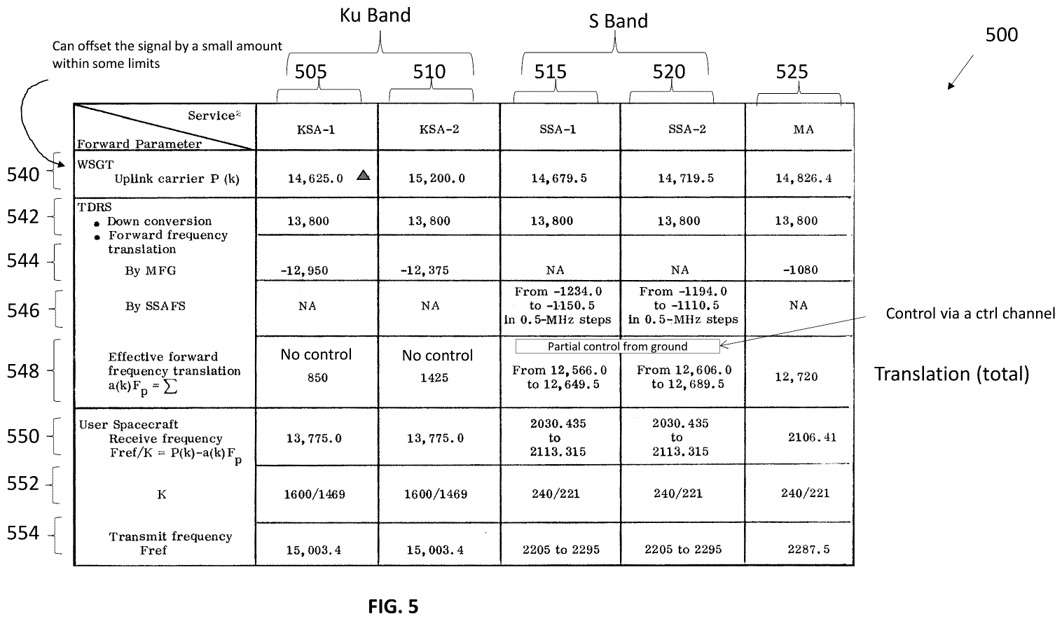

FIG. 5 illustrates an example list of operational parameters of a Tracking and Data Relay Satellite (TDRS);

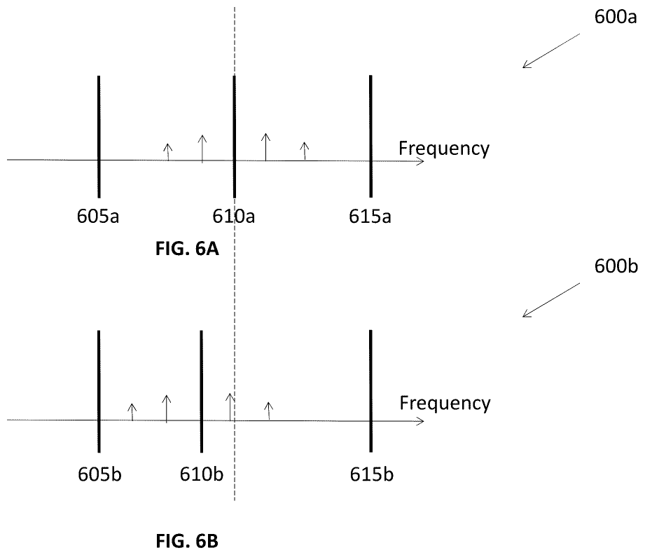

FIGS. 6A-6B illustrate examples of an uplink carrier frequency with an offset;

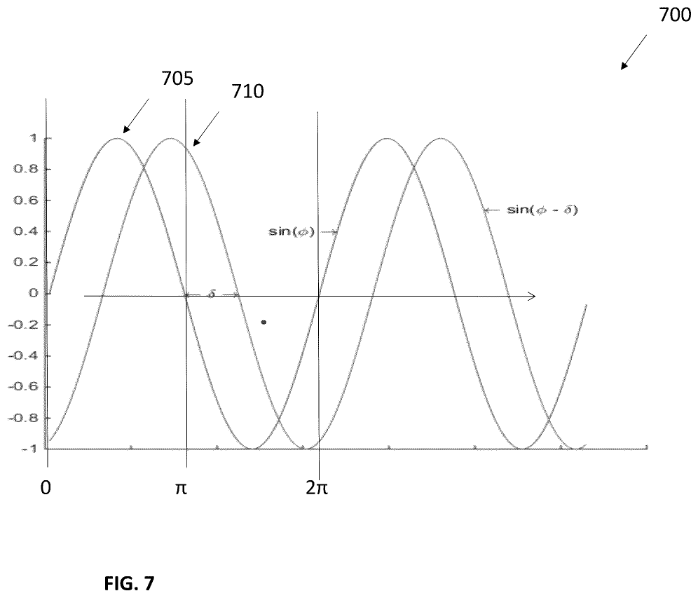

FIG. 7 illustrates an example of multiple possible signals at the output of a phase-lock loop (PLL) synchronized to a beacon signal;

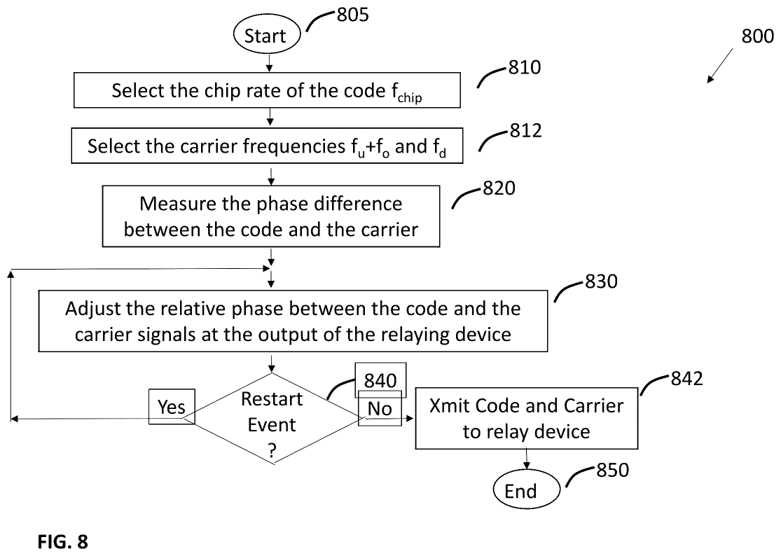

FIG. 8 illustrates an example procedure for ensuring that the phase of a code is synchronized with the phase of a carrier at a relaying device;

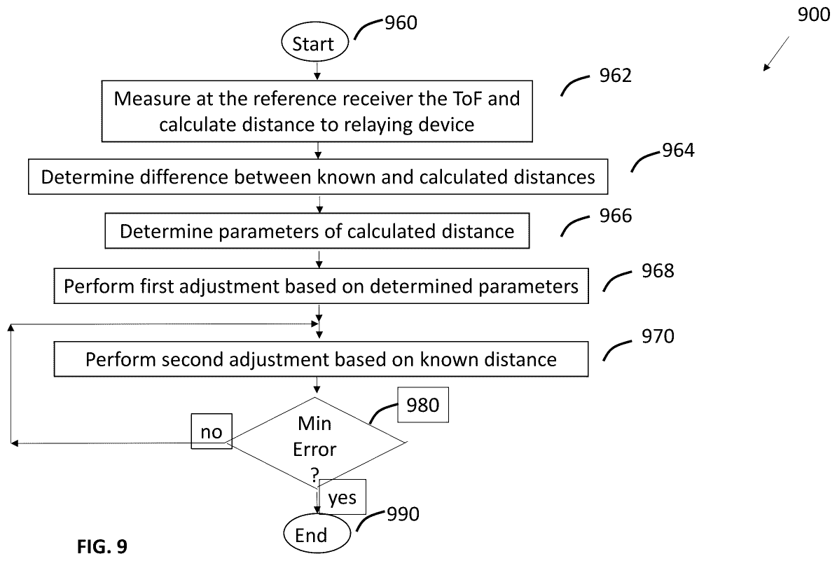

FIG. 9 illustrates an example process which aligns the phase of the code with the phase of the carrier;

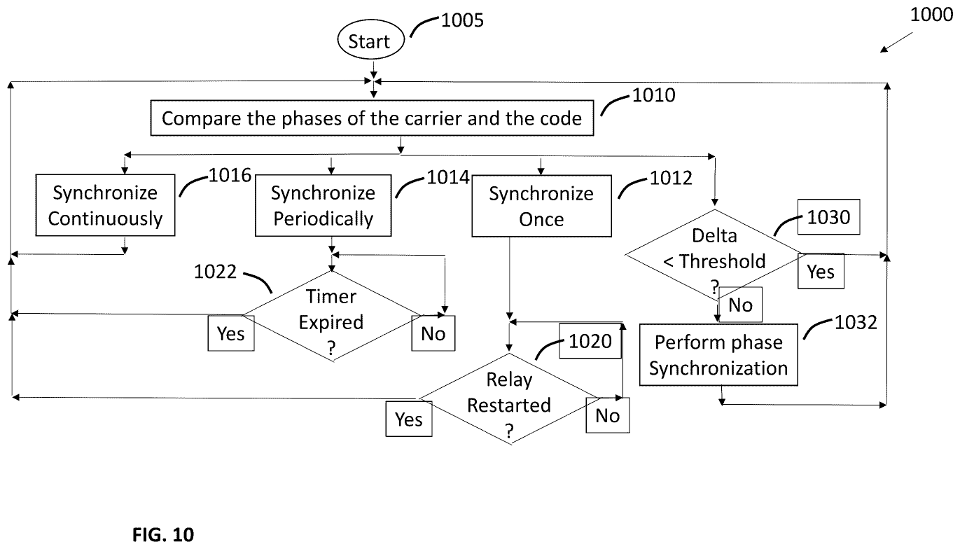

FIG. 10 illustrates an example process which maintains the alignment of the phase of the code with the phase of the carrier;

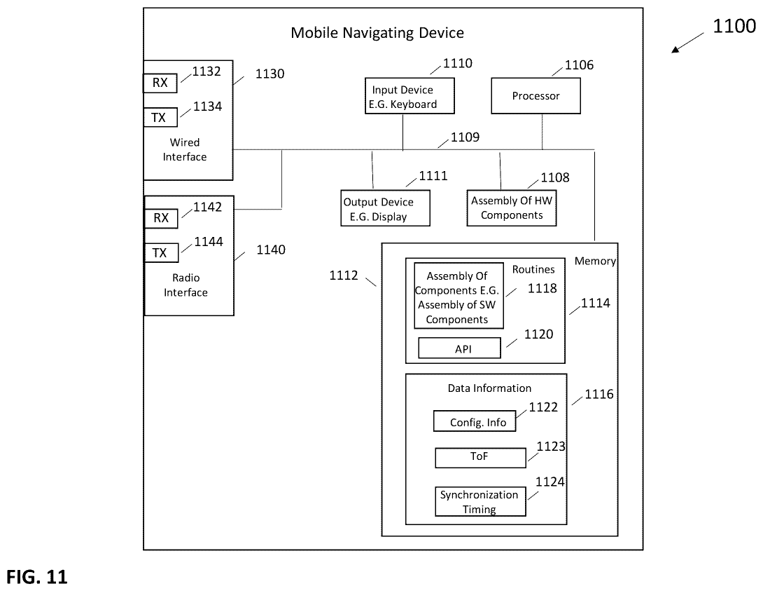

FIG. 11 illustrates an example of a navigating device; and

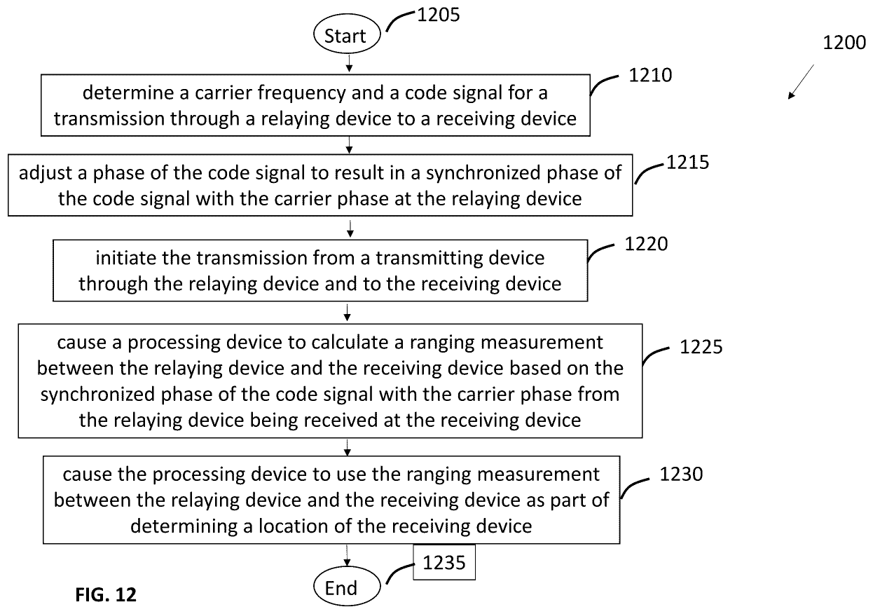

FIG. 12 illustrates an example process for synchronizing a code with a carrier.

### DESCRIPTION OF EXAMPLE EMBODIMENTS

FIG. 1 is an example illustration of a traditional Global Navigation Satellite Systems (GNSS) system. System 100 includes a navigating device, such as a handheld device 110, which receives location determination signals 112, 114, 116, and 118 from GNSS satellites 122, 124, 126, and 128, respectively. The navigating signals carry synchronized time stamps indicative of the time of flight (ToF) of the navigating signals from the GNSS to the navigating device. The fact that the code and the carrier originate from the satellite makes it easy to synchronize the phase of the code with the carrier resulting in a more accurate estimate of the time of arrival (ToA) of the code embedded in the received signal from the GNSS.

FIG. 2 illustrates an example communication system 200. User device 210 uses communication satellites such as satellites 222, 224, 226, 228 to communicate with user devices 250a through 250n. Communication satellites 222, 224, 226, and 228 and ground station 230 use communication links 212a, 212b, 214a, 214b, 216a, 216b, 218a, 218b, 231, 251a through 225n, and 261 and 271 to provide communication links for the communication infrastructure. Encryption server 260 performs encryption and decryption services on the transmitted and received messages. Chip synchronization server 270 ensures that the phase of the carrier and the phase of the code are aligned at the output of the relaying device (the transponding) device such as, e.g., a Tracking and Data Relay Satellite (TDRS) as explained in greater detail below (e.g., performing a carrier/code phase synchronization process).

System 200 of FIG. 2 is also used to provide location determination in accordance with the present disclosure. Navigation system 200 includes a navigating device, such as a handheld device 210, which sends and receives location determination signals via communication links 212a, 214a, 216a, and 218a to and from communication satellites 222, 224, 226, and 228. In one specific scenario the communication satellites may be GEO satellites such as, but not limited to, TDRS. The navigation signals which traverse communication links 112a, 114a, 116a, and 118a may be transponded or relayed from the satellites of the signals transmitted from the navigating device. Alternatively, the signals from the satellites may be received and relayed via a ground station 230 using communication links 212b, 214b, 216b, and 218b between satellites 222, 224, 226, and 228 and ground station 230.

In accordance with a specific implementation, the code of the ranging signal is modulated onto a carrier signal. Both the phase of the code and the phase of the carrier are controlled by the ground station. In accordance with another implementation the phase of the code of the ranging signal and the phase of the carrier signal are controlled by the navigating device.

Notably, to improve the ToA estimation, and therefore the location determination at the navigating device, it is important to ensure that the phase of the code is synchronized with the phase of the carrier on transmission from the transponding satellite. Such synchronization, however, requires a method to ensure for signals transmitted from a ground device that the carrier signal is phase synchronized with the code at the output of the relaying satellite.

For instance, FIGS. 3A-3B illustrate signals schematics illustrating a GNSS signal. In particular, FIG. 3A illustrates a simplified model (signals 300a) whereas FIG. 3B illustrates a similar but more detailed model (signals 300b). Because GNSS (including GPS) signals originate at the navigation satellite, it is easy to synchronize the code and the carrier. The signals 300a/b illustrates such a GNSS signal including the synchronization between the navigation data message 305a/b (data and code signal), the chip clock 310a/b, and the carrier signal 315a/b. Specifically, at time to the code and the carrier cross the zero at the same time and are said to be synchronized or aligned. Since the signals herein, on the other hand, originate from a ground station, synchronizing the code and the carrier at the transmitting relaying device, e.g., a communication satellite, is a challenge.

The techniques herein, therefore, provide for systems and methods for synchronizing a spreading code with a carrier, such as for Global Navigation Satellite Systems (GNSS) and associated codes which incorporate a navigation message modulated by a spreading code with a carrier, e.g., for facilitating precise measurement of time of flight (ToF) of received weak signals which are relayed via an intermediary device. Specifically, the techniques herein provide for synchronizing the phase of a spreading code with the phase of the relayed carrier signal. The techniques herein ensure that at a relaying device, the phase of a code modulated by a carrier signal is aligned with the phase of the carrier signal.

To aid in understanding, with reference to example environment 400 of FIG. 4, a transmitter, such as a ground station, for example, may send a communication toward a satellite using its oscillator (Oᵤₚ) and a carrier up frequency (Cᵤₚ). The satellite—using its own oscillator (O_{down}) within its mixer—shifts the transmission frequency to C_{down}, as may be appreciated by those skilled in the art. To achieve the desired result, that is, having a proper alignment of the code and carrier for the transmission by the satellite toward the receiver (e.g., a mobile device, such as for precise distance measurement signals or otherwise), the techniques herein ensure such synchronization through a calibrated phase shift by the oscillator of the transmitter (e.g., the ground station), accordingly.

Notably, in a specific implementation, TDRS operates as a telecommunication signal relay station between a ground station and user device. Other satellite relays could also be used. To avoid adding additional requirements on the TDRS, no data processing, except coherent frequency translation, is performed during the relay process.

A composite uplink signal (a carrier modulated by code) from a ground station is received by the TDRS antenna. The uplink signal is converted into a downlink signal and the new composite (downlink carrier and code) is transmitted to the navigating device. The downlink carrier may be at higher or lower frequencies than the uplink carrier frequency. In accordance with a specific implementation the carrier frequency conversion may be implemented in stages wherein the signal is first down-converted (or up-converted) to intermediate frequency (IF), and only then translated into a downlink carrier frequency before being transmitted to a navigating device such as a user device, a vehicle, to a spacecraft, or other flying object.

In another implementation, the return signals from user device or a spacecraft are frequency translated by the return processor in the relaying satellite, combined by the multiplexer in the relaying satellite to form a composite signal, then up-converted and downlinked to the ground station. Two downlink channels are available: composite (multiple access) and dedicated (single-access). In a specific implementation a dedicated channel is reserved for high data rate K-band Single-Access (KSA) and S-band Single-Access (SSA) forward channels.

The forward and return KSA and SSA signals are translated by frequencies from the Master Frequency Generator (MFG). The forward and return S-band Single-access (SSA) signals are additionally frequency translated by the forward and return SSA Frequency Synthesizer (SSAFS). The SSAFS translation frequencies are selectable via ground command in steps of 0.5 MHz.

Some of the specific operational parameters of the TDRS satellites are provided in table 500 of FIG. 5. Those skilled in the art would recognize that the TDRS satellite as well as the specific parameters provided in this table are brought just for sake of example and should not be considered as a limiting for either only TDRS satellites or to its specific parameters.

Table 500 provides some of the key operational parameters associated with a TDRS satellite. TDRS satellites operate in S-band and Ku-band. The operational parameters for the Ku KSA-1 channel are provided in column 505 and the operational parameters for the Ku KSA-2 channel are provided in column 510. Similarly, the operational parameters for the S SSA-1 channel are provided in column 515 and the operational parameters for the S SSA-2 channel are provided in column 520. The operational parameters for channel multiple access (MA) are provided in column 525.

Row 540 provides the uplink frequency of channels sent from the ground to the satellite. As illustrated in FIG. 6A, this frequency depicts the center of the specific channel. Using this carrier frequency enables the transmitting device (sending to the satellite) to utilize the whole bandwidth of the channel. However, as explained in greater detail below, a system in accordance with the techniques herein may offset the frequency of the uplink carrier to facilitate phase synchronization with the goal of increasing the accuracy of determining a position of an object.

FIG. 6B provides illustration 600b of an uplink carrier frequency with an offset in accordance with the techniques herein. Illustration 600a of FIG. 6A describes a traditional carrier f_{c} 610a located at the middle of the transmission channel between lower channel frequency fₗ 605a and upper channel frequency fᵤ 615a. The advantage of this configuration is that the system can transmit data with a bandwidth of (fᵤ−fₗ)/2 which is the nominal bandwidth the channel can transmit.

As explained below in greater detail, however, the system herein may want to offset the uplink carrier frequency for synchronizing the code with the carrier. FIG. 6B, on the other hand, provides an illustration 600b of a system with an offset carrier signal. The carrier f_{c} 610b is not located at the middle of the transmission channel between lower channel frequency fₗ 605b and upper channel frequency fᵤ 615b. The present disclosure refers to the difference between the nominal carrier frequency f_{c} 610a and the actual uplink carrier frequency f_{c} 610b as an offset frequency “fₒ”. As such, in this configuration the system can transmit data with a bandwidth of only f_{c}−fₗ which is clearly lower than the nominal (fᵤ−fₗ)/2 bandwidth. Accordingly, in some implementations where the frequency of the uplink carrier needs to be adjusted, the effective bandwidth of the signal may need to be reduced. Additionally, the frequency offset is limited by the effective nominal bandwidth of the channel.

Similarly, though not explicitly described, it should be clear that when the frequency of the carrier is chosen above the middle of the transmission channel, the system can transmit data with a bandwidth of only fᵤ−f_{c} which is clearly lower than the nominal (fᵤ−fₗ)/2 bandwidth.

Returning to row 540 of FIG. 5, Column 505 indicates that the frequency of the uplink carrier for the KSA-1 is 14,625 MHz, Column 510 indicates that the frequency of the uplink carrier for the KSA-2 is 15,200 MHz, Column 515 indicates that the frequency of the uplink carrier for the SSA-1 is 14,679.5 MHz, Column 520 indicates that the frequency of the uplink carrier for the SSA-2 is 14,719.5 MHz, and Column 525 indicates that the frequency of the uplink carrier for the MA-1 is 14,826.4 MHz.

Rows 542 and 546 provide frequencies internal to the receiver which in turn determine the effective frequency of the internal satellite receiver translation frequency (translation) illustrated in row 548. Specifically, Column 505 indicates that for the KSA-1 channel the resulting total translation is 850 MHz; column 510 indicates that for the KSA-2 channel the resulting translation is 1,425 MHz; column 515 indicates that for the SSA-1 channel the resulting translation is variable and can be controlled from 125,556 to 12,649.5 MHz in 0.5 MHz steps. Similarly, column 520 indicates that for the SSA-2 channel the resulting translation is variable and can be controlled from 125,606 to 12,689.5 MHz in 0.5 MHz steps. Column 525 indicates for the MA channel the resulting translation is 12,720 MHz. The control of the effective translation is performed by the telemetry and control channel from the ground.

Rows 550, 552, and 554 refer to user spacecraft receive frequencies, multiplier/divider K values, and transmit frequencies, accordingly, as will be appreciated by those skilled in the art.

It should be noted that the table is brought only for the sake of explanation and without limiting the frequencies that are covered by the techniques herein. Other relaying devices with their specific different frequencies are covered by this invention as well.

In general, the transmitting device can modify the following parameters:
a. the timing (phase) of the code modulating the uplink carrier;
b. the frequency of the uplink carrier within limits and tradeoffs discussed with respect to FIGS. 6A-6B; and
c. for SSA, the frequency of the forward (downlink) carrier in discrete steps of 0.5 MHz.

It is well established that to improve the accuracy of the ToA measurement, the phases of the code and carrier must be synchronized at the output of the transmitting satellite. In other words, the carrier phase and code chip period must cross 0 at same time. Such synchronization in a ranging waveform leads to greater precision in ranging as well as, more importantly in some implementations, provides greater immunity to multipath distortion. For additional explanation regarding the use of signal with a code phase synchronized with the phase of the carrier please see “Braasch, M., Van Dierendonick, A. (1999). GPS Receiver Architectures and Measurements. 1. Proceedings of the IEEE; 87”, or U.S. Pat. No. 5,471,217A “Method and apparatus for smoothing code measurements in a global positioning system receiver”.

In traditional GNSS systems, where both carrier and code are generated in and transmitted from the satellite, it is rather simple to ensure that these two signals are synchronized. However, when both signals are generated in a ground device and relayed via a communication device, special accommodation must be made to ensure that the carrier/code synchronization of the transponded ranging signal exists in the composite signal leaving the transponder, rather than at the output of the source ground device transmitter.

In accordance with a specific implementation where a TDRS is used as a relaying satellite the following restrictions may apply. (The specific restrictions are brought for sake of illustration and the invention is applicable to other relaying devices where different restrictions may apply.) In particular, restrictions/characteristics of the TDRS transponder are:
1. It does not have its own oscillator, instead it has a Master Frequency Generator (MFG) which is phase-locked to a pilot signal from the ground.
   a. Since the pilot frequency is affected by Doppler shift, a Doppler compensation may be automatically applied to all downlinks.
2. All frequency translations are therefore coherent with the carrier generated at the ground station.
3. The uplink channel center is fixed for all bands; however the techniques herein can offset the uplink signal relative to the uplink channel center by an arbitrary, but small, amount (limited by the uplink channel bandwidth available).
4. The transponding translation is:
   a. Fixed (for Ku-band);
   b. Controllable by discrete steps only (for S-band), governed by:

$${f}_{1} = 900 + 0.5 * {n}_{1}$$

$${f}_{2} = 900 + 0.5 * {n}_{2}$$

with n₁=501, 502, . . . , 668 and n₂=421, 422, . . . , 588.
5. The downlink has bandwidth limited to 80 MHz (S-band) or 50 MHz (Ku-band)
   Notably, the carrier phase is:

$$2 π {f}_{d} * t + {θ}_{D , 0} \qquad Eq . 1$$

where f_{d}=Downlink carrier frequency, and θ_{d,0}=Downlink phase at time t=0.

The code period is:

$${T}_{chip} = 1 / {f}_{chip} \qquad Eq . 2$$

where, T_{chip}=chip time period, and f_{chip}=chip frequency. To ensure that the code and the carrier are synchronized the techniques herein ensure that:

$$2 π {f}_{d} * t + {θ}_{d , 0} = 0 \qquad Eq . 3$$

for any t=n₃*T_{chip}, where n₃=any integer.

If it can be assumed that θ_{d,0}=0, then a necessary and sufficient condition is:

$${f}_{d} = {n}_{4} * {f}_{chip} \qquad Eq . 4$$

where n₄=any integer.

Therefore, the frequency of the downlink must be an integer multiple of the chip rate in order to guarantee synchronization.

Similarly, the uplink frequency is selected as an integer or a rational multiple of the chip rate:

$${f}_{u} = {n}_{5} * {f}_{chip} \qquad Eq . 5$$

where n₅=any integer or certain rational numbers.

To increase the accuracy of the ranging measurement (e.g., measurement of ToF and/or ToA), the chip rate is selected based on the maximum available bandwidth. In a specific implementation when TDRS is used, the chip rate is dictated based on the downlink channel bandwidth.

In accordance with a specific implementation, to simplify the design and implementation of the receiver, it is desired to keep the chip rate the same for all frequency bands.

The chip rate, f_{chip}, may be chosen to maximize bandwidth within the constraints of the transponder, which also maximizes ranging accuracy. Due to the restrictions on the transponder, the frequency translation at the transponder, f_{T}, may be fixed, so the uplink offset fₒ (offset of our signal from uplink carrier frequency) is then chosen using this relationship:

$${f}_{d} = {f}_{u} + {f}_{o} - {f}_{T} = {n}_{6} * {f}_{chip} \qquad Eq . 6$$

where: f_{d}=Downlink carrier frequency; fᵤ=Uplink channel center frequency; fₒ=Offset of our signal from uplink carrier frequency; f_{T}=Translation frequency at transponder; n₆=an integer; and f_{chip}=chip rate.

In the case that the translation frequency is selectable in discrete steps, both it and the uplink offset are chosen in combination.

Regarding phase ambiguity, in a specific implementation the carrier signal at the output of relaying device, e.g., the downlink carrier from a relaying satellite, is generated by a phase-locked loop (PLL) synchronized to a signal, e.g., a beacon signal, from the ground station. In some implementations the PLL uses a frequency divider. As such the frequency of the signal at the output of the PLL, fₒ, is related to the frequency of the input synchronizing signal fₗ divided by n, where n is an integer based on the specific implementation of the PLL. FIG. 7 provides an illustration of multiple possible waveforms at the output of a PLL locked to a beacon signal. A beacon frequency at higher frequency is divided by n by the PLL and is locked to the input frequency of the beacon signal. Since the input signal crosses the zero n times more than the output of signal at the output of the PLL, the beacon signal crosses the zero as the phase of the signal at the output of the PLL is one of {0, 2π/n 4π/n, 6π/n, 8π/n, etc.}.

Because the output of the PLL can lock to any one of these zero crossings the output of the PLL can have one of multiple phases depending on the specific synchronization instance of the PLL to the zero crossing of the input signal. FIG. 7 provides an illustration 700 of two out of n possible signals generated at the output of the PLL. Signal 705 may be generated if the PLL locks to the beacon signal at the specific time 0. However, if the PLL locks into one of the next zero crossings, signal 710 is generated at the output at the PLL. Signal 710 is delayed by δ where δ is one of the angles {0, 2π/n 4π/n, 6π/n, 8π/n, etc.}. For example, signal 710 illustrates a sine wave delayed by an angle δ.

In accordance with a specific implementation such as TDRS, the PLL at the satellite divides the beacon frequency by an integer n, e.g., 5, resulting in phase ambiguity among five different possible signals based on randomness in the PLL lock time at power up when the system is restarted. One skilled in the art will understand the phase ambiguity is discrete and defined by the factor of the PLL divider, in the case of TDRS it is 5, so θ_{D,0}={0, 2π/5, 4π/5, 6π/5, 8π/5, etc.}. In addition, the phase can be disturbed by external factors such as a cosmic ray event, which may cause the phase to “skip” by one of those discrete values. Both the startup and “skip” phase ambiguities must be controlled in order to ensure the code and carrier stay synchronized at the downlink.

To eliminate this ambiguity, the techniques herein control the code phase, e.g., by delaying it. In one example implementation the system utilizes a control loop to adjust the relative phase between the code and the carrier. To mitigate the ambiguity the system uses one or more receivers in a well-known location such that the distance between the relaying satellite and the well-known location is known with high accuracy. The present disclosure will refer to a receiver located in such location as a “reference receiver.” The system then measures the phase between the code and the downlink carrier and adjusts the relative phase between the transmitted code chips and the carrier to ensure that the resulting phase between the downlink carrier and any chip of the code is synchronized. In some specific implementations the system may use multiple reference locations to improve the accuracy of the phase alignment.

In accordance with one implementation the measurement is performed continuously. In accordance with another implementation the measurement is performed periodically. The measurements are performed to determine θ_{D},t at any given time t. Once measured, a phase correction on the uplink phase θ_{U,t} is performed to force the downlink carrier phase and code time to be synchronized at the output of the relaying transmitter.

FIG. 8 provides an example flow chart of a process 800 that ensures that the phase of the code is synchronized with the phase of the carrier at the relaying device. In accordance with one implementation the synchronization is performed by a computing device at the ground station. In accordance with another implementation the synchronization is performed by a computing device at the navigating device.

The process starts at operation 805 and proceeds to operation 810 where the chip rate of the code is selected. As explained above, the chip rate, f_{chip}, may be chosen to maximize bandwidth within the constraints of the transponder, which also maximizes ranging accuracy The process proceeds to operation 812 where the computing device then selects the final uplink carrier frequency (fᵤ+fₒ) and downlink carrier frequency f_{d}. The selection of the uplink and downlink frequencies is governed by equations Eq. 5 and Eq. 6 above ensuring that the uplink and downlink frequencies are integer multipliers of the code frequency.

For example, in one specific implementation, the method may select in operation 810 a code chip rate of 4 MHz, and in operation 812 an uplink frequency of 3670*4 MHz=14,680 MHz and a downlink carrier frequency of 507*4 MHz=2028 MHz. The method then verifies that the uplink signal falls within the available transponder uplink bandwidth and the downlink signal falls within the available transponder downlink bandwidth. Using the example above, the method verifies that the resulting uplink signal falls within the uplink bounds of [14,639.5-14,719.5] MHz and the downlink signal falls within the bounds of [2030.435-2013.315] MHz. In accordance with one implementation, the method places the carrier in the middle of the channel in order to maximize the available bandwidth for the signal. In accordance with another example implementation, the system positions the carrier closer to the edge of the bandwidth as to facilitate fitting another signal closer to the other edge of that bandwidth.

Those skilled in the art would recognize that since the frequency of the downlink carrier signal equals the frequency of the uplink carrier minus the translation frequency of the relaying device. Therefore, similar ratios between the chip rate of the code, the frequency of the uplink signal, and the frequency of the downlink signal may be achieved by controlling and selecting the frequency of the local oscillator of the relaying device, e.g., the satellite.

Similarly, the frequency selection does not need to start by selecting/determining the chip rate of the code. Those skilled in the art would recognize that the method may start by selecting any one of the other frequencies such as the frequency of the uplink carrier, the frequency of the downlink carrier, or the frequency of the local oscillator in the relaying device. All of the combinations of the orders of operations leading to the uplink carrier frequency being an integer multiplier of the code chip rate and the downlink carrier frequency being also an integer multiplier of the code chip rate are covered by the present disclosure.

Once the frequencies of the uplink and downlink have been determined, in operation 820 the phase difference between code and carrier is measured, and operation 830 adjusts the phase of the carrier relative to the phase of the code at the transmitting station so that code and carrier are aligned at the output of the relaying device, e.g., the downlink transmitter of a communication satellite. The alignment process is described in greater detail in FIG. 9 below. Operation 840 determines whether a restart event was detected. If the operation determines that a restart event occurred, the method loops back to operation 830 where the phases of the code and the carrier are aligned again. However, if operation 840 does not detect a restart operation, in operation 842 the code and carrier are transmitted towards the relaying device, e.g., satellite. The process 800 ends in step 850.

FIG. 9 provides an example of process 900 which aligns the phase of the code with the phase of the carrier. The process starts at operation 960 and proceeds to operation 962 where the code ToA is estimated at a reference receiver, then ToF is calculated and finally the “calculated distance” between the known reference receiver and the relaying device, e.g., the satellite, is determined. In operation 964 the calculated distance is compared against the known distance between the reference receiver and the relaying device and the difference is determined. Alternatively, the comparison may be performed between the determined ToF and the known ToF based on the distance between a reference location and a known location of the relaying device, e.g., a satellite. To reduce the error, the comparison may be performed multiple times.

Operation 966 determines statistical parameters of the calculated difference. For example, the operation determines mean and variance of the one or more of the calculated ToF, the calculated distance, the difference between the known ToF to the relaying device and the measured ToF, and the difference between the known distance to the relaying device and the calculated distance, etc. Operation 968 utilizes the determined parameters to perform a first synchronization operation of the phase of the code and the carrier. For example, the phase of the carrier is adjusted to minimize the calculated variance. In accordance with another example implementation the phase of the carrier is adjusted to minimize one or more of the variance, the mean of the difference between calculated and known distances, or the mean of the difference between measured ToF and known ToF of a signal travelling between the reference location and the relaying device.

In accordance with another example implementation the system utilizes multiple reference locations and determines for each location the ToF between the known location of the ground station and the known location of the relaying satellite. For each reference location the system determines one or more of: the difference between the measured ToF and the ToF that a signal between the reference location and the relaying device should experience, the known distance between the reference location and the relaying satellite and the distance calculated based on the measured ToF.

The system then determines a set of parameters that minimize a measure of the aggregate differences, for example, but not limited to, a root mean square of the differences.

For example, the system may minimize the measure of the difference by optimizing one or more of the relative phase between the code and the carrier, the specific sinusoidal signal as described in greater details in reference with FIG. 7, etc.

Operation 970 performs a second alignment between the phases of the carrier and the code. The second alignment is performed to remove the phase ambiguity. As described above, depending on the specific implementation of the relaying device receiver, the first phase adjustment may minimize (or optimize) a statistical measure of the measured ToF by converging at a ToF which is off by 2π/n where n is an integer based on specific implementation of the reference receiver. As part of the second alignment process operation 970 examines the error between the measured and known distances and selects (aligns) the relative phase between the code and the carrier as to result in a minimal discrepancy between the measured and known distances. Operation 980 loops back to operation 970 until the phase that results in a minimal difference between the distances is detected, The process ends at step 990.

FIG. 10 provides an example of a process 1000 that aligns the phase of the code with the phase of the carrier. The method starts in operation 1005 and continues to operation 1010 where the phase of the carrier and the phase of the code are compared and the difference is employed in the process of synchronizing and or aligning the two phases. In accordance with one implementation (operation 1012) the synchronization is performed once. Operation 1020 checks whether the relaying device, e.g., a satellite, was restarted or suffered from intermittent failure. If the operation determines that a restart occurred, the method loops back to operation 1010 where a new “one time” synchronization process starts. However as long as a restart of the relaying device is not detected, no new phase alignment is triggered.

In accordance with a second example implementation the synchronization is performed periodically. Once phase synchronization is performed in operation 1014, operation 1022 determines whether a timer with a predetermined (or configurable) period of time expired. As long as the timer does not expire, the method loops back to operation 1022. However, once operation 1022 determines that the timer expired, the method loops back to operation 1010 and a new phase synchronization process starts.

In accordance with a third example implementation (operation 1016) the synchronization is performed continuously. As soon as phase adjustment is performed, the method loops back to operation 1010 and a new phase synchronization process starts. In accordance with a fourth example implementation, operation 1030 compares the time or phase difference between the zero-crossing (rising or falling) edge of the chips of the code and the zero-crossing (rising or falling) edge of the carrier signal. If operation 1030 determines that the difference is smaller than a predetermined threshold, the method loops back to operation 1010 without performing any phase synchronization. However, if operation 1030 determines that the delta between the phases is greater than a pre-determined threshold, synchronization is performed in operation 1032. The method then loops back to operation 1010 where new phase synchronization starts.

It should be noted that while certain steps within the flowcharts may be optional and the steps shown in the Figures are merely examples for illustration, and certain other steps may be included or excluded as desired. Furthermore, while a particular order of the steps is shown, this ordering is merely illustrative, and any suitable arrangement of the steps may be utilized without departing from the scope of the embodiments herein. Moreover, the methods are described separately, certain steps from each procedure may be incorporated into one or more of the other methods and the various steps are not meant to be mutually exclusive.

FIG. 11 is a drawing of navigating device 1100 in accordance with an example embodiment herein.

Navigating device 1100 includes wired interfaces 1130, wireless interfaces e.g., radio interface 1140, a processor 1106, e.g., a CPU, a memory 1112, and an assembly of modules 1108, e.g., assembly of hardware module, e.g., assembly of circuits, coupled together via a bus 1109 over which the various elements may interchange data and information. Wired interface 1130 includes receiver 1132 and transmitter 1134. The wired interface and/or the wireless interface couples the navigating device 1100 to a network and/or the Internet 240 of FIG. 2. Wireless radio interface 1140 includes receiver 1142 and transmitter 1144. For sake of simplicity only one radio wireless interface is illustrated while the navigating device may include more than a single radio interface. The wireless interfaces 1140 may support a Wi-Fi interface, e.g., 802.11 interfaces, satellite communication interface, Bluetooth interface, etc.

Memory 1112 includes routines 1114, and data/information 1116. Routines 1114 include assembly of modules 1118, e.g., an assembly of software modules, and Application Programming Interface (API) 1120. Data/information 1116 includes configuration information 1122, ToF 1123 and synchronization timing 1124 to mark the time when the code and carrier are phase synchronized.

Input device 1110, e.g., keyboard, touch screen, etc., facilitates entering information, e.g., configuration information, into the navigating device and output device 1111, e.g., screen, LEDs, speakers, etc., facilitates conveying info ration by the navigating device to an operator, or alternatively to a direction determination system (not shown) such as airplane rudder, steering device, etc.

Aligning the zero crossing of two signals is a sufficient but not a necessary condition for aligning two signals and because of its simplicity it is used to simplify the explanation. Those skilled in the art should recognize that two signals can be synchronized by e.g., forcing one signal to cross the zero amplitude when the second signal is at any specific angle. And even more generally, two signals can be synchronized by e.g., forcing one signal to be at a first specific angle when the second signal is at any specific second angle. In a specific implementation, the transmitting device periodically changes the angle between the carrier and the code and conveys the information via an encrypted channel to the navigating device, e.g., as part of the ranging message. As a result, any other system that attempts to utilize the ranging signal for its own navigation would not be able to achieve as accurate a navigation result. Only authorized systems which can access the encrypted information about the variable delay would be able to obtain the robustness and accuracy of the system with knowledge of the variable angle.

FIG. 12 provides an example of process 1200 (e.g., a method) which synchronizes a code with a carrier. The process starts at step 1205 (e.g., at a device, such as a transmitting device, or other configured controller device), and proceeds to step 1210 where, as described above, the device determines a carrier frequency and a code signal for a transmission through a relaying device to a receiving device.

In step 1215, the device adjusts a phase of the code signal to result in a synchronized phase of the code signal with the downlink carrier phase at the relaying device.

In step 1220, the device initiates the transmission from a transmitting device through the relaying device and to the receiving device.

In one embodiment, in step 1225, a processing device is caused to calculate a ranging measurement between the relaying device and the receiving device based on the synchronized phase of the code signal with the carrier phase from the relaying device being received at the receiving device. In one embodiment, in step 1230, the processing device is caused to use the ranging measurement between the relaying device and the receiving device as part of determining a location of the receiving device.

Process 1200 ends in step 1235. Notably, other steps may be included within process 1200, such as various operations described above in various embodiments of the techniques herein, and those shown within FIG. 12 are not meant to be limiting to the scope of the present disclosure.

Advantageously, the techniques herein thus provide for synchronizing a spreading code with a carrier. According to embodiments of the present disclosure, an illustrative method herein may comprise: determining, by a device, a carrier frequency and a code signal for a transmission through a relaying device to a receiving device; adjusting, by the device, a phase of the code signal to result in a synchronized phase of the code signal with a downlink carrier phase at the relaying device; and initiating, by the device, the transmission from a transmitting device through the relaying device and to the receiving device.

In one embodiment, a processing device is caused to calculate a ranging measurement between the relaying device and the receiving device based on the synchronized phase of the code signal with the downlink carrier phase from the relaying device being received at the receiving device. In one embodiment, the processing device uses the ranging measurement between the relaying device and the receiving device as part of determining a location of the receiving device. In one embodiment, the ranging measurement is selected from a group consisting of: a time of flight of the transmission between the relaying device and the receiving device; a distance between the relaying device and the receiving device and the time of arrival of the transmission at the receiving device.

In one embodiment, the processing device is selected from a group consisting of: the transmitting device; the receiving device; and a third device that is neither the transmitting device nor the receiving device.

In one embodiment, a location of the receiving device is known, a location of the relaying device is known, and the ranging measurement between the relaying device and the receiving device is known, and the method further comprises: calibrating adjustment to the phase of the code signal such that the ranging measurement as calculated by the processing device based on the synchronized phase of the code signal with the downlink carrier phase from the relaying device being received at the receiving device is correct.

In one embodiment, the receiving device is a reference receiver, and adjusting comprises: determining a known ranging measurement between the relaying device and the reference receiver; determining one or more statistical measures of the ranging measurement calculated by the processing device; and varying a relative phase between the code signal and the carrier signal to either minimize or maximize at least one of the one or more statistical measures.

In one embodiment, the receiving device is a reference receiver, and adjusting comprises: determining a known ranging measurement between the relaying device and the reference receiver; determining a difference between the known ranging measurement and the ranging measurement calculated by the processing device; and varying the phase of the code signal to minimize the difference. In one embodiment, varying the phase comprises: changing the phase in increments of 2π/n, where n is an integer selected dependent upon the relaying device.

In one embodiment, the method further comprises: calibrating adjustment to the phase of the code signal based on confirming ranging measurements to a plurality of reference receivers.

In one embodiment, the synchronized phase of the code signal with the downlink carrier phase results in a zero crossing of the downlink carrier phase and a zero crossing of the code signal occurring at a fixed predetermined angle at an output of the relaying device, and the method further comprises: conveying the fixed predetermined angle to the processing device. In one embodiment, the method further comprises: dynamically adjusting the fixed predetermined angle to avoid adversarial access to the fixed predetermined angle; and updating the processing device based on dynamically adjusting the fixed predetermined angle.

In one embodiment, the synchronized phase of the code signal with the downlink carrier phase results in a zero crossing of the downlink carrier phase coinciding with a zero crossing of the code signal at an output of the relaying device.

In one embodiment, the method further comprises: offsetting an uplink carrier phase to facilitate phase synchronization.

In one embodiment, the carrier frequency is one of either an integer multiplier of a chip rate of the code signal or a rational multiplier of the chip rate.

In one embodiment, the method further comprises: selecting a chip rate of the code signal.

In one embodiment, the relaying device is a communication satellite.

In one embodiment, the device is the transmitting device.

In one embodiment, the transmitting device is the receiving device.

Additionally, an illustrative tangible, non-transitory, computer-readable medium herein may store program instructions that cause a computer of a device to execute a method comprising: determining a carrier frequency and a code signal for a transmission through a relaying device to a receiving device; adjusting a phase of the code signal to result in a synchronized phase of the code signal with the downlink carrier phase at the relaying device; and initiating the transmission from a transmitting device through the relaying device and to the receiving device.

Moreover, an illustrative apparatus herein may comprise: a processor configured to execute one or more processes; a communication interface; and a memory configured to store a process executable by the processor that when executed is configured to perform a method comprising: determining a carrier frequency and a code signal for a transmission through a relaying device to a receiving device; adjusting a phase of the code signal to result in a synchronized phase of the code signal with the downlink carrier phase at the relaying device; and initiating the transmission from a transmitting device through the relaying device and to the receiving device.

Furthermore, an illustrative system herein may comprise: a transmitting device configured to transmit, on a first carrier frequency, a transmission having a code signal; a relaying device configured to relay the transmission on a second carrier frequency; and a receiving device configured to receive the transmission from the relaying device; wherein a phase of the code signal is adjusted at the transmitting device to result in a synchronized phase of the code signal with a downlink carrier phase at the relaying device.

According to additional and/or alternative embodiments of the present disclosure, an illustrative method herein for determining the time of arrival of a navigation signal received via a relaying device may comprise: selecting one or more of uplink carrier frequency, downlink carrier frequency, and code chip rate; synchronizing by a transmitting device the phase of the code and the carrier at the relaying device; and determining the position of a navigating device based on the synchronized signal.

In one embodiment, the frequencies of the uplink carrier and the downlink carrier are one of an integer multiplier of the code rate and a rational multiplier of the code rate.

In one embodiment, synchronizing the phase of the code and the phase of the carrier comprises: determining the ToF between a relaying device and a reference receiver; determining a statistical measure of the measured ToF; and varying the relative phase between the code and the carrier as to one of: minimizing and maximizing at least one statistical measure.

In one embodiment, synchronizing the phase of the code and the phase of the carrier comprises: measuring the ToF between the relaying device and the reference receiver; determining the difference between the measured ToF and the known ToF between the reference receiver and the relaying device; varying the phase between the code and the carrier to minimize the determined difference; and transmitting, from a transmitting device, carrier and code signals with the relative phase that minimized the difference. In one embodiment, varying the phase between the code and the carrier comprises changing the relative phase in increments of 2π/n where n is an integer that depends on the implementation of the relaying device.

In one embodiment, synchronizing the phase of the code and the phase of the carrier comprises: determining the calculated distance between the reference receiver and the relaying device; determining the difference between the calculated distance and the known distance between the reference receiver and the relaying device; varying the phase between the code and the carrier to minimize the determined difference; and transmitting, from a transmitting device, carrier and code signals with the relative phase that minimized the difference. In one embodiment, varying the phase between the code and the carrier comprises changing the relative phase in increments of 2π/n where n is an integer that depends on the implementation of the relaying device.

In one embodiment, synchronizing the phase of the code and the carrier at the relaying device ensures that the zero crossing of the carrier and the zero crossing of the chip coincide at the output of the relaying device.

In one embodiment, synchronizing the phase of the code and the carrier at the relaying device ensures that the zero crossing of the carrier and the zero crossing of the chip occur at a fixed predetermined angle and wherein the information about the predetermined fixed angle are conveyed to the navigating device. In one embodiment, an adversary system that does not have access to the predetermined fixed angle cannot achieve the same level of accuracy of navigation based on the transmitted code and carrier by the relaying device.

In one embodiment, multiple reference points are used to increase the accuracy of the phase alignment.

In one embodiment, the method herein may further comprise offsetting the frequency of the uplink carrier to facilitate phase synchronization with the goal of increasing the accuracy of determining a position of an object.

Additionally, an illustrative tangible, non-transitory, computer-readable medium herein may store program instructions that cause a computer of a particular device to execute a method comprising: selecting on or more of uplink carrier frequency, downlink carrier frequency, and code chip rate; synchronizing by a transmitting device the phase of the code and the carrier at the relaying device; and determining the position of a navigating device based on the synchronized signal.

Moreover, an illustrative apparatus herein may comprise: a processor configured to execute one or more processes; a communication interface; and a memory configured to store a process executable by the processor that when executed is configured to: select on or more of uplink carrier frequency, downlink carrier frequency, and code chip rate; synchronize by a transmitting device the phase of the code and the carrier at the relaying device; and determine the position of a navigating device based on the synchronized signal.

While there have been shown and described illustrative embodiments, it is to be understood that various other adaptations and modifications may be made within the scope of the embodiments herein. For example, the embodiments may, in fact, be used in a variety of types of wireless communication networks and/or protocols, and need not be limited to the illustrative satellite network implementation. Furthermore, while the embodiments may have been demonstrated with respect to certain communication environments, physical environments, or device form factors, and in particular satellite communication environments, other configurations may be conceived by those skilled in the art that would remain within the contemplated subject matter of the description above, including other types of wireless communication mediums aside from satellite communications.

Additionally, for the sake of simplicity, in some places, the above description stated that the techniques herein adjust the phase of the carrier to align with the phase of the code, while in other places above the disclosure discusses implementations where the system adjusted the phase of the code to align with the phase of the carrier. Those skilled in the art should understand that in all cases the phase of one of these signals is adjusted for the phase of the other signal, with the same result of aligning the phase between the two signals. Moreover, it should be noted that the techniques herein may either adjust the code phase or the carrier phase, accordingly.

It will also be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Notably, in other embodiments, user intervention is not necessary at certain “user equipment”, and as such, various automated terminals, drones/UAVs, weaponry, etc., may employ the techniques herein. The use of the term “user” herein thus is not meant to be limiting to the scope of the types of devices implementing the techniques herein.

Furthermore, in the detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

In particular, the foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a device, a carrier frequency and a code signal for a transmission through a relaying device to a receiving device;
adjusting, by the device, a phase of the code signal to result in a synchronized phase of the code signal with a downlink carrier phase at the relaying device; and
initiating, by the device, the transmission from a transmitting device through the relaying device and to the receiving device.

2. The method as in claim 1, wherein a processing device is caused to calculate a ranging measurement between the relaying device and the receiving device based on the synchronized phase of the code signal with the downlink carrier phase from the relaying device being received at the receiving device.

3. The method as in claim 2, wherein the processing device uses the ranging measurement between the relaying device and the receiving device as part of determining a location of the receiving device.

4. The method as in claim 2, wherein the ranging measurement is selected from a group consisting of: a time of flight of the transmission between the relaying device and the receiving device; a time of arrival of the transmission at the receiving device; and a distance between the relaying device and the receiving device.

5. The method as in claim 2, wherein the processing device is selected from a group consisting of: the transmitting device; the receiving device; and a third device that is neither the transmitting device nor the receiving device.

6. The method as in claim 2, wherein a location of the receiving device is known, a location of the relaying device is known, and the ranging measurement between the relaying device and the receiving device is known, the method further comprising:
calibrating adjustment to the phase of the code signal such that the ranging measurement as calculated by the processing device based on the synchronized phase of the code signal with the downlink carrier phase from the relaying device being received at the receiving device is correct.

7. The method as in claim 2, wherein the receiving device is a reference receiver, and wherein adjusting comprises:
determining a known ranging measurement between the relaying device and the reference receiver;
determining one or more statistical measures of the ranging measurement calculated by the processing device; and
varying a relative phase between the code signal and the downlink carrier phase to either minimize or maximize at least one of the one or more statistical measures.

8. The method as in claim 2, wherein the receiving device is a reference receiver, and wherein adjusting comprises:
determining a known ranging measurement between the relaying device and the reference receiver;
determining a difference between the known ranging measurement and the ranging measurement calculated by the processing device; and
varying the phase of the code signal to minimize the difference.

9. The method as in claim 8, wherein varying the phase comprises:
changing the phase in increments of 2π/n, where n is an integer selected dependent upon the relaying device.

10. The method as in claim 2, further comprising:
calibrating adjustment to the phase of the code signal based on confirming ranging measurements to a plurality of reference receivers.

11. The method as in claim 2, wherein the synchronized phase of the code signal with the downlink carrier phase results in a zero crossing of the downlink carrier phase and a zero crossing of the code signal occurring at a fixed predetermined angle at an output of the relaying device, the method further comprising:
conveying the fixed predetermined angle to the processing device.

12. The method as in claim 11, further comprising:
dynamically adjusting the fixed predetermined angle to avoid adversarial access to the fixed predetermined angle; and
updating the processing device based on dynamically adjusting the fixed predetermined angle.

13. The method as in claim 1, wherein the synchronized phase of the code signal with the downlink carrier phase results in a zero crossing of the downlink carrier phase coinciding with a zero crossing of the code signal at an output of the relaying device.

14. The method as in claim 1, further comprising:
offsetting an uplink carrier phase to facilitate phase synchronization.

15. The method as in claim 1, wherein the carrier frequency is one of either an integer multiplier of a chip rate of the code signal or a rational multiplier of the chip rate.

16. The method as in claim 1, further comprising:
selecting a chip rate of the code signal.

17. The method as in claim 1, wherein the relaying device is a communication satellite.

18. The method as in claim 1, wherein the device is the transmitting device.

19. The method as in claim 1, wherein the transmitting device is the receiving device.

20. A tangible, non-transitory, computer-readable medium storing program instructions that cause a computer of a device to execute a method comprising:
determining a downlink carrier frequency and a code signal for a transmission through a relaying device to a receiving device;
adjusting a phase of the code signal to result in a synchronized phase of the code signal with a downlink carrier phase at the relaying device; and
initiating the transmission from a transmitting device through the relaying device and to the receiving device.

21. An apparatus, comprising:
a processor configured to execute one or more processes;
a communication interface; and
a memory configured to store a process executable by the processor that when executed is configured to perform a method comprising:
determining a downlink carrier frequency and a code signal for a transmission through a relaying device to a receiving device;
adjusting a phase of the code signal to result in a synchronized phase of the code signal with a downlink carrier phase at the relaying device; and
initiating the transmission from a transmitting device through the relaying device and to the receiving device.

22. A system, comprising:
a transmitting device configured to transmit, on a first carrier frequency, a transmission having a code signal;
a relaying device configured to relay the transmission on a second carrier frequency; and
a receiving device configured to receive the transmission from the relaying device;
wherein a phase of the code signal is adjusted at the transmitting device to result in a synchronized phase of the code signal with a downlink carrier phase at the relaying device.
